(19) United States
(12) Patent Application Publication
(10) Pub. No.: US 2025/0356119 A1
(43) Pub. Date: Nov. 20, 2025

(54) INFORMATION PROCESSING DEVICE, AND GENERATION METHOD

(71) Applicant: Mitsubishi Electric Corporation, Tokyo (JP)

(72) Inventor: Hiroyasu ITSUI, Tokyo (JP)

(73) Assignee: Mitsubishi Electric Corporation, Tokyo (JP)

(21) Appl. No.: 19/291,221

(22) Filed: Aug. 5, 2025

Related U.S. Application Data
(63) Continuation of application No. PCT/JP2023/018077, filed on May 15, 2023.

(51) Int. Cl. G06F 40/268

(52) U.S. Cl. CPC G06F 40/268

(57) ABSTRACT

An information processing device includes an acquisition unit that acquires multiple pieces of learning data in each of which a document and a category have been associated with each other, a morphological analysis performance unit that performs morphological analysis on each of the multiple pieces of learning data, an extraction unit that extracts words being predicates from among a plurality of words obtained by the morphological analysis, and a calculation generation unit that generates a learned model by calculating pointwise mutual information based on the plurality of words obtained by the morphological analysis, a plurality of extracted words, and a plurality of categories, the learned model being a learned model which outputs a category corresponding to data when the data is inputted.

### CROSS-REFERENCE TO RELATED APPLICATION

This application is a continuation application of International Application No. PCT/JP2023/018077 having an international filing date of May 15, 2023, all of which is hereby expressly incorporated by reference into the present application.

### BACKGROUND OF THE INVENTION

### 1. Field of the Invention

The present disclosure relates to an information processing device, and a generation method.

### 2. Description of the Related Art

In the field of language, the technology of Artificial Intelligence (AI) is being used. For example, there has been proposed a learned model that infers the meaning of a word included in a character string (see Patent Reference 1). The learned model in the Patent Reference 1 is generated by means of unsupervised learning.
Patent Reference 1: WO 2022/049668

In cases where the unsupervised learning is used as in the above-described technology, there is a problem in that inference accuracy of the learned model generated by means of the unsupervised learning is low.

### SUMMARY OF THE INVENTION

An object of the present disclosure is to generate a learned model having high inference accuracy.

An information processing device according to an aspect of the present disclosure is provided. The information processing device includes an acquisition unit that acquires multiple pieces of learning data in each of which a document and a category have been associated with each other, a morphological analysis performance unit that performs morphological analysis on each of the multiple pieces of learning data, an extraction unit that extracts words being predicates from among a plurality of words obtained by the morphological analysis, and a calculation generation unit that generates a learned model by calculating pointwise mutual information based on the plurality of words obtained by the morphological analysis, a plurality of extracted words, and a plurality of categories, the learned model being a learned model which outputs a category corresponding to data when the data is inputted.

According to the present disclosure, a learned model having high inference accuracy can be generated.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing the configuration of hardware included in an information processing device in a first embodiment;

FIG. 2 is a block diagram showing functions included in the information processing device in a learning phase in the first embodiment;

FIG. 3 is a diagram showing a concrete example of a process executed by the information processing device in the first embodiment;

FIGS. 4(A) and 4(B) are diagrams showing examples of the image of a learned model in the first embodiment;

FIG. 5 is a block diagram showing functions included in an information processing device in a utilization phase in the first embodiment;

FIG. 6 is a diagram showing an example of the image of the learned model in the second embodiment;

FIG. 7 is a block diagram showing functions included in an information processing device in the learning phase in a third embodiment;

FIG. 8 is a diagram showing a concrete example of a process executed by the information processing device in the third embodiment;

FIG. 9 is a diagram showing an example of the image of a first learned model in the third embodiment;

FIG. 10 is a block diagram showing functions included in an information processing device in the utilization phase in the third embodiment; and

FIG. 11 is a diagram showing a concrete example of a process executed by a second learned model in the third embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

### Learning Phase

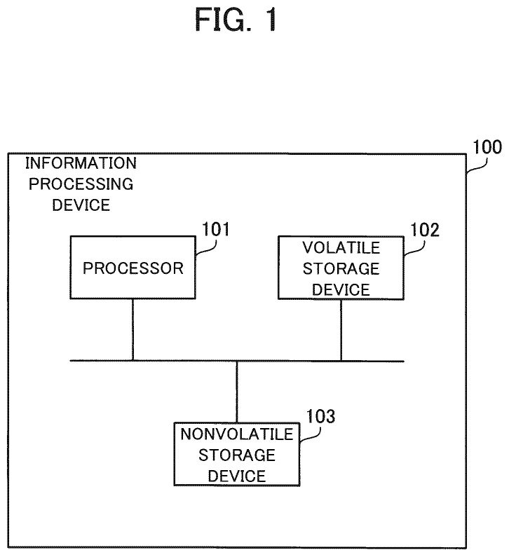

FIG. 1 is a diagram showing the configuration of hardware included in an information processing device in a first embodiment. The information processing device 100 is a device that executes a generation method. The information processing device 100 can be referred to also as a learning device. Further, the information processing device 100 can be referred to also as a computer.

The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions of the information processing device 100 will be described below.

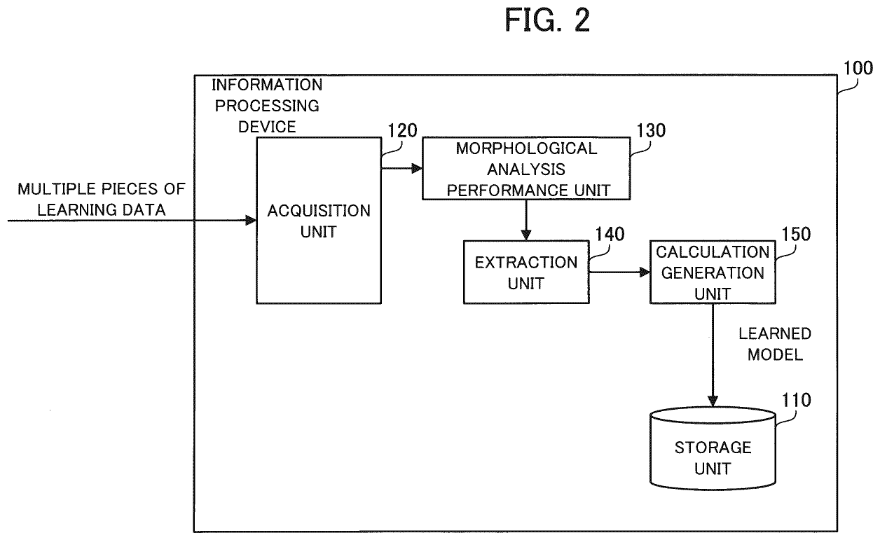

FIG. 2 is a block diagram showing functions included in the information processing device in a learning phase in the first embodiment. The information processing device 100 includes a storage unit 110, an acquisition unit 120, a morphological analysis performance unit 130, an extraction unit 140 and a calculation generation unit 150.

The storage unit 110 may be implemented as a storage area reserved in the volatile storage device 102 or the nonvolatile storage device 103.

Part or all of the acquisition unit 120, the morphological analysis performance unit 130, the extraction unit 140 and the calculation generation unit 150 may be implemented by processing circuitry. Part or all of the acquisition unit 120, the morphological analysis performance unit 130, the extraction unit 140 and the calculation generation unit 150 may be implemented as modules of a program executed by the processor 101. For example, the program executed by the processor 101 is referred to also as a generation program. The generation program has been recorded in a record medium, for example.

The acquisition unit 120 acquires multiple pieces of learning data. For example, the acquisition unit 120 acquires the multiple pieces of learning data from the storage unit 110. Alternatively, for example, the acquisition unit 120 acquires the multiple pieces of learning data from an external device. The external device is a cloud server, for example. Incidentally, illustration of the external device is left out. In each of the multiple pieces of learning data, a document and a category have been associated with each other. Further, the document can be represented also as a character string. The category may be regarded as a label in supervised learning.

The morphological analysis performance unit 130 performs morphological analysis on each of the multiple pieces of learning data.

The extraction unit 140 extracts words being predicates from among a plurality of words obtained by the morphological analysis. For example, the extraction unit 140 extracts the words being predicates in regard to each result of the morphological analysis of learning data. Specifically, the extraction unit 140 executes the following process for each document. The extraction unit 140 extracts words being predicates from among a plurality of words obtained by performing the morphological analysis on the document. Incidentally, each of the words being predicates is a word being a verb, an adjective, an adjective verb or a sa-column irregular conjugation noun (in the Japanese language).

Here, a process executed by the acquisition unit 120, the morphological analysis performance unit 130 and the extraction unit 140 will be described below by using a drawing.

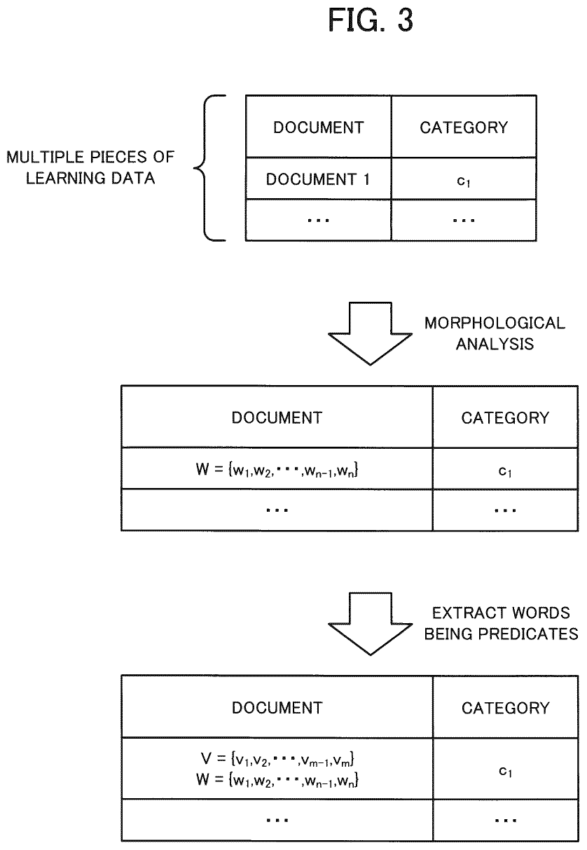

FIG. 3 is a diagram showing a concrete example of a process executed by the information processing device in the first embodiment. FIG. 3 indicates multiple pieces of learning data. For example, the acquisition unit 120 acquires learning data in which a “document 1” and a category “C₁” have been associated with each other.

Here, a set C of categories is represented by expression (1).

$$C = \{ {c}_{1} , {c}_{2} , … , {c}_{l - 1} , {c}_{l} \} \qquad ( 1 )$$

The morphological analysis performance unit 130 performs the morphological analysis on each of the multiple pieces of learning data. Incidentally, “W” in FIG. 3 represents a set of words. Further, “w” in FIG. 3 represents each word obtained by the morphological analysis.

The extraction unit 140 extracts words being predicates in regard to each result of the morphological analysis of learning data. For example, the extraction unit 140 extracts the words being predicates from among “W” of the “document 1”.Incidentally, “V” in FIG. 3 represents a set of the words being predicates. Further, “v” in FIG. 3 represents each word being a predicate.

The calculation generation unit 150 generates a learned model by calculating pointwise mutual information (PMI) based on the plurality of words obtained by the morphological analysis, a plurality of extracted words (i.e., a plurality of words being predicates), and a plurality of categories. The calculation generation process will be described in detail below. The calculation generation unit 150 calculates the PMI regarding a case of co-occurrence of vᵢ, wⱼ and cₚ. Specifically, the calculation generation unit 150 calculates the PMI by using expression (2). Incidentally, P represents an appearance probability (probability of appearance) in the document as the learning data. For example, P(vᵢ) represents the appearance probability of the word vᵢ being a predicate in the document. Further, i, j and p are arbitrary values.

$$PMI ( {v}_{i} , {w}_{j} , {c}_{p} ) = {log}_{2} \frac{P ( {v}_{i} , {w}_{j} , {c}_{p} )}{P ( {v}_{i} ) P ( {w}_{j} ) P ( {c}_{p} )} \qquad ( 2 )$$

Incidentally, when the PMI is negative, the PMI is regarded as 0. The learned model is the PMI(vᵢ, wⱼ, cₚ). The calculation generation unit 150 generates the learned model as above. When data is inputted to the learned model, the learned model is capable of outputting a category corresponding to the data. Further, the learned model is also capable of outputting a likelihood.

Here, the learned model can be represented as follows.

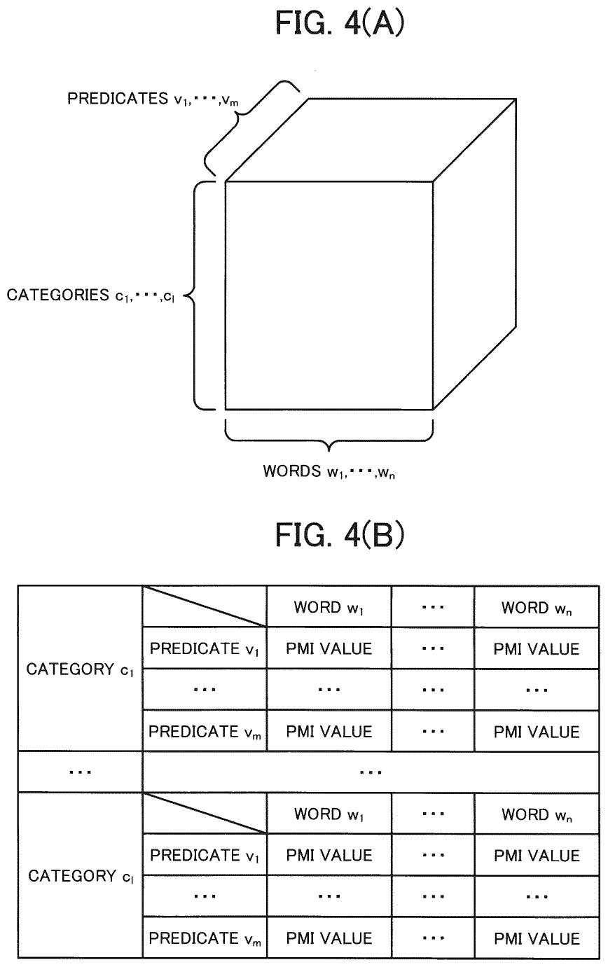

FIGS. 4(A) and 4(B) are diagrams showing examples of the image of the learned model in the first embodiment. For example, the learned model is represented as in FIG. 4(A).

FIG. 4(B) shows a case where the learned model in FIG. 4(A) is represented as a table. Information indicating a correspondence relationship between a word w and a word v being a predicate is two-dimensional information. Then, information indicating a correspondence relationship between a category c and the two-dimensional information is three-dimensional information. Therefore, the learned model is represented as three-dimensional information. Further, the learned model may be expressed also as a third-order tensor.

Further, when the number of appearances on vᵢ and wⱼ are less than or equal to a predetermined threshold value, the calculation generation unit 150 may correct the PMI(vᵢ, wⱼ, cₚ) by using a constant α. In other words, the calculation generation unit 150 may correct the learn model. Specifically, the calculation generation unit 150 makes the correction by using expression (3).

$$CORRECTED LEARNED MODEL = PMI ( {v}_{i} , {w}_{j} , {c}_{p} ) + ( PMI ( {v}_{i} , {c}_{p} ) + PMI ( {w}_{j} , {c}_{p} ) ) \cdot α \qquad ( 3 )$$

When the number of appearances on vᵢ and wⱼ are less than or equal to the threshold value as above, it can be considered that the amount of learning for generating the learned model is small. Therefore, the calculation generation unit 150 corrects the learned model. Accordingly, the information processing device 100 is capable of increasing the inference accuracy of the learned model.

The calculation generation unit 150 stores the learned model in the storage unit 110. The calculation generation unit 150 may also store the learned model in the external device.

Here, in cases where unsupervised learning is used, there is a problem in that the inference accuracy of the learned model generated by means of the unsupervised learning is low.

According to the first embodiment, the information processing device 100 generates the learned model by using supervised learning. The inference accuracy of the learned model generated by means of the supervised learning is high. Therefore, the information processing device 100 is capable of generating a learned model having high inference accuracy.

Further, in cases where the unsupervised learning is used, a great amount of learning data is used. In contrast, in the supervised learning, the learned model can be generated by using a small amount of learning data. Therefore, the information processing device 100 is capable of generating the learned model by using a small amount of learning data.

### Utilization Phase

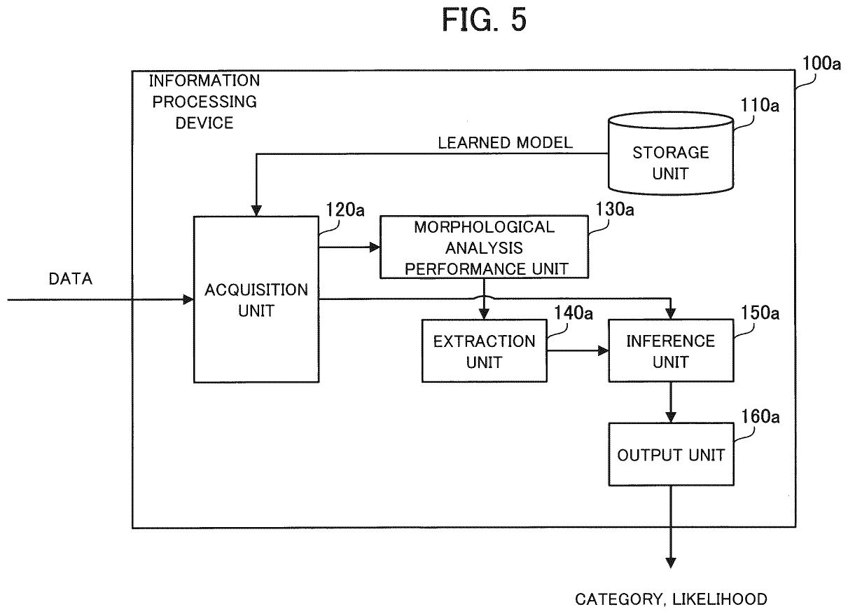

FIG. 5 is a block diagram showing functions included in an information processing device in a utilization phase in the first embodiment. The information processing device 100a includes a storage unit 110a, an acquisition unit 120a, a morphological analysis performance unit 130a, an extraction unit 140a, an inference unit 150a and an output unit 160a. Further, the information processing device 100a can be referred to also as an inference device.

Here, the information processing device 100 and the information processing device 100a may be either the same device or different devices. For example, when the information processing device 100 and the information processing device 100a are the same device, the information processing device 100a further includes the inference unit 150a and the output unit 160a. Further, when the information processing device 100 and the information processing device 100a are the same device, the storage unit 110 and the storage unit 110a may be considered to be the same as each other. Furthermore, when the information processing device 100 and the information processing device 100a are the same device, functions of the acquisition unit 120a, the morphological analysis performance unit 130a and the extraction unit 140a may be considered to be the same as the functions of the acquisition unit 120, the morphological analysis performance unit 130 and the extraction unit 140.

The storage unit 110a may be implemented as a storage area reserved in a volatile storage device or a nonvolatile storage device included in the information processing device 100a.

Part or all of the acquisition unit 120a, the morphological analysis performance unit 130a, the extraction unit 140a, the inference unit 150a and the output unit 160a may be implemented by processing circuitry included in the information processing device 100a. Part or all of the acquisition unit 120a, the morphological analysis performance unit 130a, the extraction unit 140a, the inference unit 150a and the output unit 160a may be implemented as modules of a program executed by a processor included in the information processing device 100a.

The acquisition unit 120a acquires data including characters. For example, the acquisition unit 120a acquires the data from the storage unit 110a. Alternatively, for example, the acquisition unit 120a acquires the data from the external device.

Further, the acquisition unit 120a acquires a learned model. For example, the acquisition unit 120a acquires the learned model from the storage unit 110a. Alternatively, for example, the acquisition unit 120a acquires the learned model from the external device.

The morphological analysis performance unit 130a performs the morphological analysis on the data. For example, a set W of words obtained by the morphological analysis is represented by expression (4).

$$W = \{ {w}_{1} , {w}_{2} , … , {w}_{n - 1} , {w}_{n} \} \qquad ( 4 )$$

The extraction unit 140a extracts words being predicates from the result of the morphological analysis. For example, a set V of the extracted words is represented by expression (5).

$$V = \{ {v}_{1} , {v}_{2} , … , {v}_{m - 1} , {v}_{m} \} \qquad ( 5 )$$

The inference unit 150a infers a category corresponding to the data acquired by the acquisition unit 120a by using a plurality of words obtained by the morphological analysis, the extracted words (i.e., the words being predicates), and the learned model.

The learned model calculates a value L(cₚ) in regard to each category as shown in expression (6).

$$L ( {c}_{p} ) = {\sum }_{i = 1}^{m} {\sum }_{j = 1}^{n} PMI ( {v}_{i} , {w}_{j} , {c}_{p} ) \qquad ( 6 )$$

Incidentally, when the learned model has been corrected, the expression (6) is represented by expression (7).

$$L ( {c}_{p} ) = {\sum }_{i = 1}^{m} {\sum }_{j = 1}^{n} PMI ( {v}_{i} , {w}_{j} , {c}_{p} ) + ( PMI ( {v}_{i} , {c}_{p} ) + PMI ( {w}_{j} , {c}_{p} ) ) \cdot α \qquad ( 7 )$$

After the calculation of the value L(cₚ) in regard to each category, the learned model outputs a category CM corresponding to a maximum value as shown in expression (8).

$$CM = arg max \{ L ( {c}_{p} ) \} \qquad ( 8 )$$

As above, it is inferred that the category corresponding to the data acquired by the acquisition unit 120a is the category CM.

Further, the learned model outputs the likelihood.

The output unit 160a outputs the category CM and the likelihood. For example, the output unit 160a outputs the category CM and the likelihood to a display of the information processing device 100a.

### Second Embodiment

Next, a second embodiment will be described below. In the second embodiment, the description will be given mainly of features different from those in the first embodiment. In the second embodiment, the description is omitted for features in common with the first embodiment.

### Learning Phase

Processing by the acquisition unit 120, the morphological analysis performance unit 130 and the extraction unit 140 in the second embodiment is the same as the processing by the acquisition unit 120, the morphological analysis performance unit 130 and the extraction unit 140 in the first embodiment.

The calculation generation unit 150 generates a learned model by calculating the pointwise mutual information based on the plurality of words obtained by the morphological analysis, the plurality of extracted words (i.e., the plurality of words being predicates), and the plurality of categories. However, in the calculation of the pointwise mutual information, the calculation generation unit 150 selects two words from the plurality of words obtained by the morphological analysis and calculates the pointwise mutual information by using the selected two words. The calculation generation process will be described in detail below. In the calculation of the pointwise mutual information, the calculation generation unit 150 selects a word wⱼ and a word wₖ from words w₁-wₙ. The calculation generation unit 150 calculates the PMI regarding a case of co-occurrence of vᵢ, wⱼ, wₖ and cₚ. Specifically, the calculation generation unit 150 calculates the PMI by using expression (9). Incidentally, P represents the appearance probability in the document as the learning data. Further, i, j, k and p are arbitrary values.

$$PMI ( {v}_{i} , {w}_{j} , {w}_{k} , {c}_{p} ) = {log}_{2} \frac{P ( {v}_{i} , {w}_{j} , {w}_{k} , {c}_{p} )}{P ( {v}_{i} ) P ( {w}_{j} ) P ( {w}_{k} ) P ( {c}_{p} )} \qquad ( 9 )$$

Incidentally, when the PMI is negative, the PMI is regarded as 0. The learned model is the PMI(vᵢ, wⱼ, wₖ, cₚ). The calculation generation unit 150 generates the learned model as above. The learned model is capable of outputting the category and the likelihood.

Here, the learned model can be represented as follows.

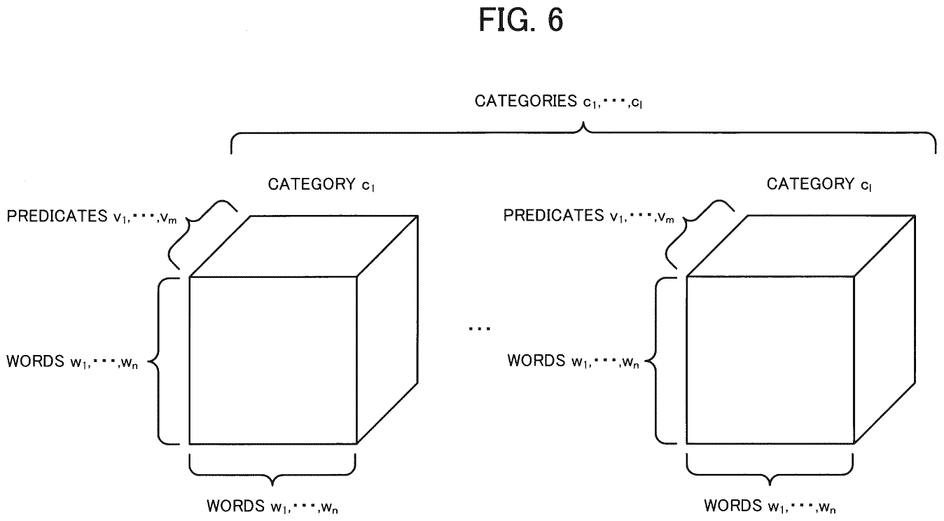

FIG. 6 is a diagram showing an example of the image of the learned model in the second embodiment. As shown in FIG. 6, the learned model is represented as four-dimensional information. Further, the learned model may be expressed also as a fourth-order tensor.

The learned model shown in FIG. 4 is three-dimensional information. On the other hand, the learned model shown in FIG. 6 is four-dimensional information. Therefore, the learned model shown in FIG. 6 has higher inference accuracy than the learned model shown in FIG. 4. Thus, according to the second embodiment, the information processing device 100 is capable of generating a learned model having higher inference accuracy.

Further, when the number of appearances on vᵢ, wⱼ and wₖ are less than or equal to a predetermined threshold value, the calculation generation unit 150 may correct the PMI(vᵢ, wⱼ, wₖ, cₚ) by using a constant α. In other words, the calculation generation unit 150 may correct the learned model. Specifically, the calculation generation unit 150 makes the correction by using expression (10).

$$CORRECTED LEARNED MODEL = PMI ( {v}_{i} , {w}_{j} , {w}_{k} , {c}_{p} ) + ( PMI ( {v}_{i} , {c}_{p} ) + PMI ( {w}_{j} , {c}_{p} ) + PMI ( {w}_{k} , {c}_{p} ) ) \cdot α \qquad ( 10 )$$

When the number of appearances on vᵢ, wⱼ and wₓ are less than or equal to the threshold value as above, it can be considered that the amount of learning for generating the learned model is small. Therefore, the calculation generation unit 150 corrects the learned model. Accordingly, the information processing device 100 is capable of increasing the inference accuracy of the learned model.

The calculation generation unit 150 stores the learned model in the storage unit 110. The calculation generation unit 150 may also store the learned model in an external device.

### Utilization Phase

Processing by the acquisition unit 120a, the morphological analysis performance unit 130a and the extraction unit 140a in the second embodiment is the same as the processing by the acquisition unit 120a, the morphological analysis performance unit 130a and the extraction unit 140a in the first embodiment.

The inference unit 150a infers the category corresponding to the data acquired by the acquisition unit 120a by using the plurality of words obtained by the morphological analysis, the extracted words (i.e., the words being predicates), and the learned model.

The learned model calculates the value L(cₚ) in regard to each category as shown in expression (11).

$$L ( {c}_{p} ) = = {\sum }_{i = 1}^{m} {\sum }_{j = 1}^{n} {\sum }_{j = 1}^{n} PMI ( {v}_{i} , {w}_{j} , {w}_{k} , {c}_{p} ) \qquad ( 11 )$$

Incidentally, when the learned model has been corrected, the expression (11) is represented by expression (12).

$$L ( {c}_{p} ) = = {\sum }_{i = 1}^{m} {\sum }_{j = 1}^{n} {\sum }_{j = 1}^{n} PMI ( {v}_{i} , {w}_{j} , {w}_{k} , {c}_{p} ) + ( PMI ( {v}_{i} , {c}_{p} ) + PMI ( {w}_{j} , {c}_{p} ) + PMI ( {w}_{k} , {c}_{p} ) ) \cdot α \qquad ( 12 )$$

After the calculation of the value L(cₚ) in regard to each category, the learned model outputs the category CM corresponding to the maximum value as shown in expression (8).

As above, it is inferred that the category corresponding to the data acquired by the acquisition unit 120a is the category CM.

Further, the learned model outputs the likelihood.

The output unit 160a outputs the category CM and the likelihood. For example, the output unit 160a outputs the category CM and the likelihood to the display of the information processing device 100a.

### Third Embodiment

Next, a third embodiment will be described below. In the third embodiment, a description will be given of a method of generating a learned model that infers the category by a method different from those in the first and second embodiments.

### Learning Phase

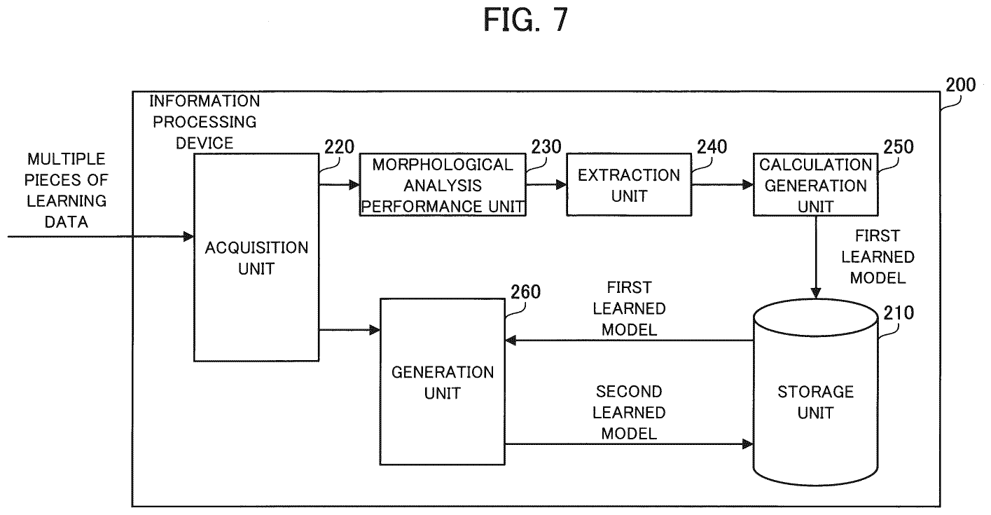

FIG. 7 is a block diagram showing functions included in an information processing device in the learning phase in the third embodiment. The information processing device 200 is a device that executes a generation method. The information processing device 200 includes a storage unit 210, an acquisition unit 220, a morphological analysis performance unit 230, an extraction unit 240, a calculation generation unit 250 and a generation unit 260. Further, the information processing device 200 can be referred to also as a computer.

The storage unit 210 may be implemented as a storage area reserved in a volatile storage device or a nonvolatile storage device included in the information processing device 200.

Part or all of the acquisition unit 220, the morphological analysis performance unit 230, the extraction unit 240, the calculation generation unit 250 and the generation unit 260 may be implemented by processing circuitry. Part or all of the acquisition unit 220, the morphological analysis performance unit 230, the extraction unit 240, the calculation generation unit 250 and the generation unit 260 may be implemented as modules of a program executed by a processor included in the information processing device 200. For example, the program executed by the processor is referred to also as a generation program. The generation program has been recorded in a record medium, for example.

The acquisition unit 220 acquires multiple pieces of learning data. For example, the acquisition unit 220 acquires the multiple pieces of learning data from the storage unit 210 or the external device. Incidentally, in each of the multiple pieces of learning data, a document and a category have been associated with each other. Parenthetically, the category may be regarded as a label in the supervised learning.

The morphological analysis performance unit 230 performs the morphological analysis on each of the multiple pieces of learning data.

The extraction unit 240 extracts words being predicates from among a plurality of words obtained by the morphological analysis. For example, the extraction unit 240 extracts the words being predicates in regard to each result of the morphological analysis of learning data. Incidentally, each of the words being predicates is a word being a verb, an adjective, an adjective verb or a sa-column irregular conjugation noun (in the Japanese language).

Here, a process executed by the acquisition unit 220, the morphological analysis performance unit 230 and the extraction unit 240 will be described below by using a drawing.

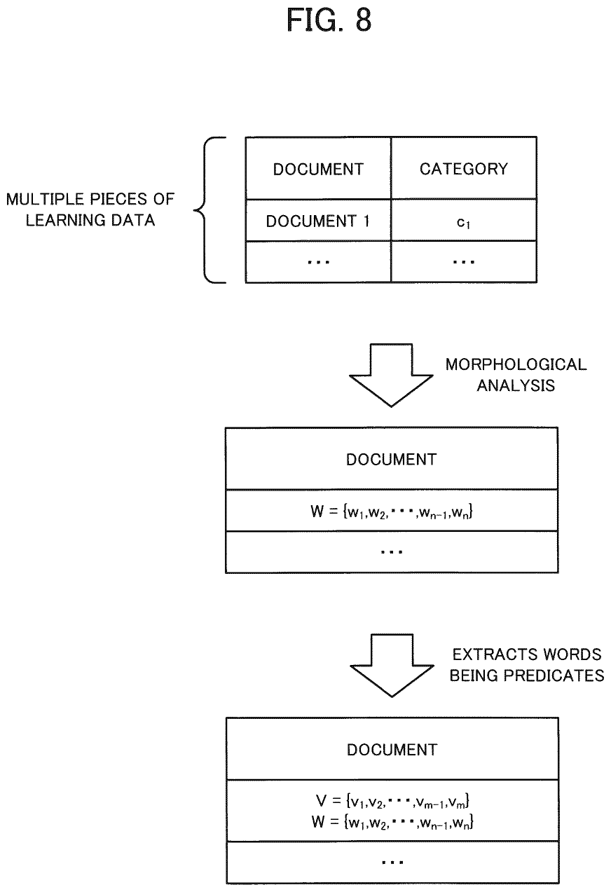

FIG. 8 is a diagram showing a concrete example of a process executed by the information processing device in the third embodiment. FIG. 8 indicates multiple pieces of learning data. For example, the acquisition unit 220 acquires learning data in which the “document 1” and the category “c₁” have been associated with each other.

Here, no category is used in the subsequent processing. Therefore, the categories are left out.

The morphological analysis performance unit 230 performs the morphological analysis on each of the multiple pieces of learning data.

The extraction unit 240 extracts words being predicates in regard to each result of the morphological analysis of learning data. For example, the extraction unit 240 extracts the words being predicates from among “W” of the “document 1”.

The calculation generation unit 250 generates a first learned model by calculating the pointwise mutual information based on the plurality of words obtained by the morphological analysis and the plurality of extracted words (i.e., the plurality of words being predicates). However, in the calculation of the pointwise mutual information, the calculation generation unit 250 selects two words from the plurality of words obtained by the morphological analysis and calculates the pointwise mutual information by using the selected two words. The calculation generation process will be described in detail below. In the calculation of the pointwise mutual information, the calculation generation unit 250 selects a word wⱼ and a word wₖ from words w₁-wₙ. The calculation generation unit 250 calculates the PMI regarding a case of co-occurrence of vᵢ, wⱼ and wₖ. Specifically, the calculation generation unit 250 calculates the PMI by using expression (13). Incidentally, i, j and k are arbitrary values.

$$PMI ( {v}_{i} , {w}_{j} , {w}_{k} ) = {log}_{2} \frac{P ( {v}_{i} , {w}_{j} , {w}_{k} )}{P ( {v}_{i} ) P ( {w}_{j} ) P ( {w}_{k} )} \qquad ( 13 )$$

Incidentally, when the PMI is negative, the PMI is regarded as 0. The first learned model is the PMI(vᵢ, wⱼ, wₖ). The calculation generation unit 250 generates the first learned model as above.

Here, the first learned model can be represented as follows.

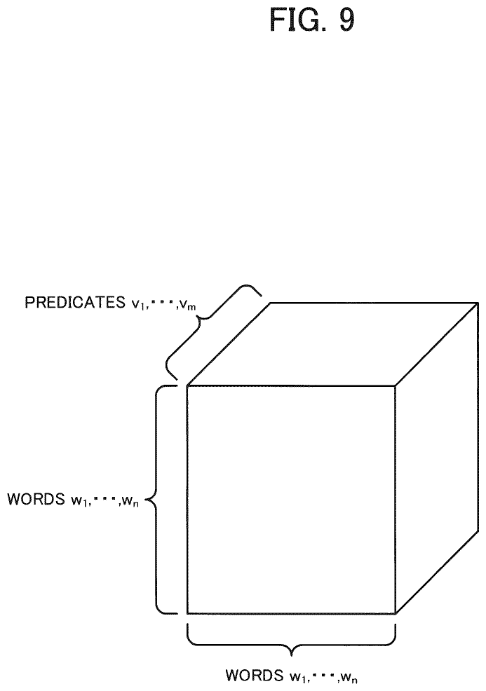

FIG. 9 is a diagram showing an example of the image of the first learned model in the third embodiment. As shown in FIG. 9, the first learned model is represented as three-dimensional information. Further, the first learned model may be expressed also as a third-order tensor.

Further, when the number of appearances on vᵢ, wⱼ and wₖ are less than or equal to a predetermined threshold value, the calculation generation unit 250 may correct the PMI(vᵢ, wⱼ, wₖ) by using a constant α. In other words, the calculation generation unit 250 may correct the first learned model. Specifically, the calculation generation unit 250 makes the correction by using expression (14). Further, when j and k are arbitrary values, w; and wₖ. form a permutation. When learning is executed under a condition j<k, it is also possible to execute the learning by interchanging words included in a sentence. For example, in a sentence “a child viewing a cat”, wⱼ is “cat” and wₖ is “child”. The “child” and the “cat” are interchanged with each other. Then, wⱼ turns into “child” and wₖ turns into “cat”. Accordingly, the phrases “a cat viewing a child” and “a child viewing a cat”, which have different meanings, are learned. Therefore, a word order-dependent meaning that cannot be learned by the conventional BoW (Bag of Words) is learned.

$$CORRECTED FIRST LEARNED MODEL = PMI ( {v}_{i} , {w}_{j} , {w}_{k} ) + ( PMI ( {v}_{i} , {w}_{j} ) + PMI ( {v}_{i} , {w}_{k} ) ) \cdot α \qquad ( 14 )$$

When the number of appearances on vᵢ, wⱼ and wₖ are less than or equal to the threshold value as above, it can be considered that the amount of learning for generating the first learned model is small. Therefore, the calculation generation unit 250 corrects the first learned model. Accordingly, the information processing device 200 is capable of increasing the inference accuracy of the first learned model.

The calculation generation unit 250 stores the first learned model in the storage unit 210. The calculation generation unit 250 may also store the first learned model in the external device.

The generation unit 260 generates a second learned model that outputs a category corresponding to data when the data is inputted thereto based on multiple pieces of learning data, the first learned model, and a predetermined method. Here, the predetermined method is a conventional method used in machine learning. The conventional method is Support Vector Machine, random forest, or the like, for example. For example, the generation unit 260 generates the second learned model by executing learning by use of multiple pieces of learning data and the first learned model according to the predetermined method so that the category corresponding to the data is outputted.

Further, in the conventional technology, words in a document as the learning data are converted to numerical vectors such as one-hot vectors or tfidf vectors. Then, the numerical vectors and categories are associated with each other and the learning is executed. As above, in the learning phase, the learning is executed by using vectors.

The generation unit 260 may also generate the second learned model that outputs the category and the likelihood. The generation unit 260 stores the second learned model in the storage unit 210. The generation unit 260 may also store the second learned model in the external device.

Here, in cases where the unsupervised learning is used, there is a problem in that the inference accuracy of the learned model generated by means of the unsupervised learning is low.

According to the third embodiment, the information processing device 200 generates the second learned model by using supervised learning. The inference accuracy of the learned model generated by means of the supervised learning is high. Therefore, the information processing device 200 is capable of generating a learned model having high inference accuracy.

### Utilization Phase

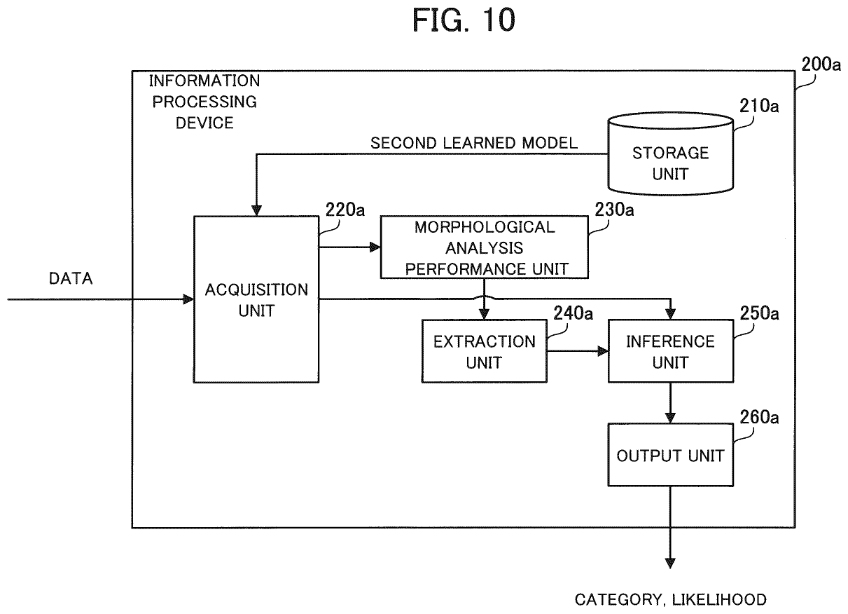

FIG. 10 is a block diagram showing functions included in an information processing device in the utilization phase in the third embodiment. The information processing device 200a includes a storage unit 210a, an acquisition unit 220a, a morphological analysis performance unit 230a, an extraction unit 240a, an inference unit 250a and an output unit 260a. Further, the information processing device 200a can be referred to as an inference device.

Here, the information processing device 200 and the information processing device 200a may be either the same device or different devices. For example, when the information processing device 200 and the information processing device 200a are the same device, the information processing device 200a further includes the inference unit 250a and the output unit 260a. Further, when the information processing device 200 and the information processing device 200a are the same device, the storage unit 210 and the storage unit 210a may be considered to be the same as each other. Furthermore, when the information processing device 200 and the information processing device 200a are the same device, functions of the acquisition unit 220a, the morphological analysis performance unit 230a and the extraction unit 240a may be considered to be the same as the functions of the acquisition unit 220, the morphological analysis performance unit 230 and the extraction unit 240.

The storage unit 210a may be implemented as a storage area reserved in a volatile storage device or a nonvolatile storage device included in the information processing device 200a.

Part or all of the acquisition unit 220a, the morphological analysis performance unit 230a, the extraction unit 240a, the inference unit 250a and the output unit 260a may be implemented by processing circuitry included in the information processing device 200a. Part or all of the acquisition unit 220a, the morphological analysis performance unit 230a, the extraction unit 240a, the inference unit 250a and the output unit 260a may be implemented as modules of a program executed by a processor included in the information processing device 200a.

The acquisition unit 220a acquires data including characters. For example, the acquisition unit 220a acquires the data from the storage unit 210a. Alternatively, for example, the acquisition unit 220a acquires the data from the external device.

Further, the acquisition unit 220a acquires the second learned model. For example, the acquisition unit 220a acquires the second learned model from the storage unit 210a. Alternatively, for example, the acquisition unit 220a acquires the second learned model from the external device.

The morphological analysis performance unit 230a performs the morphological analysis on the data.

The extraction unit 240a extracts words being predicates from the result of the morphological analysis.

The inference unit 250a infers the category corresponding to the data acquired by the acquisition unit 220a by using the plurality of words obtained by the morphological analysis, the extracted words (i.e., the words being predicates), and the second learned model. Specifically, the inference unit 250a vectorizes the plurality of words and the extracted words. The inference unit 250a infers the category corresponding to the data by using sentence vectors of distributed representations obtained by the vectorization and the second learned model. Here, a process executed by the second learned model will be described below by using a drawing.

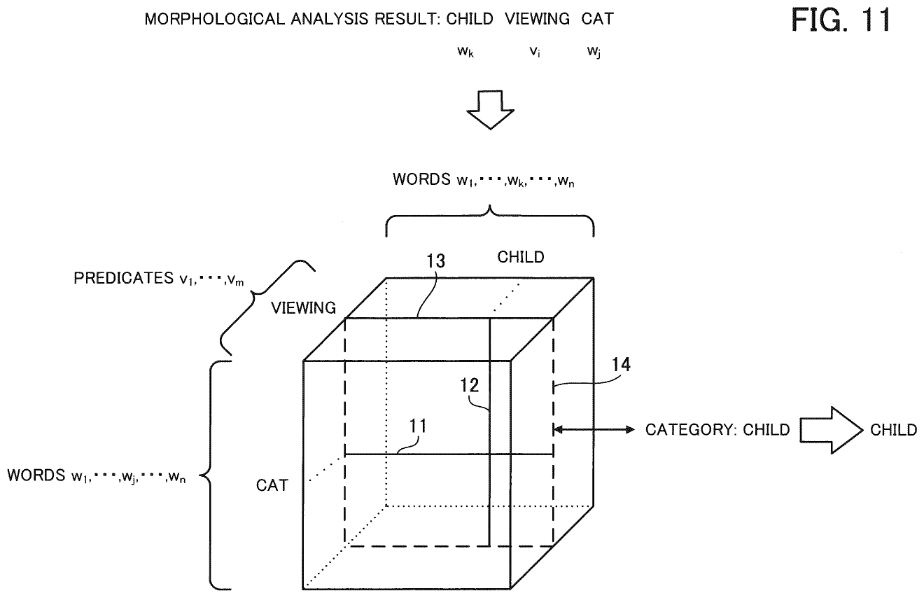

FIG. 11 is a diagram showing a concrete example of the process executed by the second learned model in the third embodiment. FIG. 11 shows the result of the morphological analysis. The result of the morphological analysis is “child”, “viewing” and “cat”. The word wⱼ is assumed to be “cat”. The word vᵢ is assumed to be “viewing”. The word wₖ is assumed to be “child”.

The second learned model detects a vector 11 in a line of “cat”. Specifically, the vector 11 is represented as “{PMI(viewing, cat, w₁), . . . , PMI(viewing, cat, wⱼ), . . . , PMI(viewing, cat, wₙ)}”.

The second learned model detects a vector 12 in a line of “child”. Specifically, the vector 12 is represented as “{PMI(viewing, w₁, child), . . . , PMI(viewing, wₖ, child), . . . , PMI(viewing, wₙ, child)}”.

The second learned model detects a vector 13 in a line of “viewing”. Specifically, the vector 13 is represented as “{{PMI(viewing, w₁, w₁), . . . , PMI(viewing, w₁, wₖ), . . . , PMI(viewing, w₁, wₙ)}”, . . . , {PMI(viewing, wⱼ, w₁), . . . , PMI(viewing, wⱼ, wₖ), . . . , PMI(viewing, wⱼ, wₙ)}“, . . . , {PMI(viewing, wₙ, w₁), . . . , PMI(viewing, wₙ, wₖ), . . . , PMI(viewing, wₙ, wₙ)}}”.

The second learned model connects the vectors 11, 12 and 13 together. The second learned model detects the category “child” corresponding to the distributed representation (i.e., sentence vector) represented by the connection. For example, in FIG. 11, this distributed representation is indicated by a plane 14. The second learned model outputs “child”.

As above, the category corresponding to the data acquired by the acquisition unit 220a is inferred.

Further, the second learned model outputs the likelihood.

The output unit 260a outputs the category and the likelihood. For example, the output unit 260a outputs the category and the likelihood to a display of the information processing device 200a.

Features in the embodiments described above can be appropriately combined with each other.

### DESCRIPTION OF REFERENCE CHARACTERS

11, 12, 13: vector, 14: plane, 100: information processing device, 100a: information processing device, 101: processor, 102: volatile storage device, 103: nonvolatile storage device, 110: storage unit, 110a: storage unit, 120: acquisition unit, 120a: acquisition unit, 130: morphological analysis performance unit, 130a: morphological analysis performance unit, 140: extraction unit, 140a: extraction unit, 150: calculation generation unit, 150a: inference unit, 160a: output unit, 200: information processing device, 200a: information processing device, 210: storage unit, 210a: storage unit, 220: acquisition unit, 220a: acquisition unit, 230: morphological analysis performance unit, 230a: morphological analysis performance unit, 240: extraction unit, 240a: extraction unit, 250: calculation generation unit, 250a: inference unit, 260: generation unit, 260a: output unit

What is claimed is:

1. An information processing device comprising:
acquiring circuitry to acquire multiple pieces of learning data in each of which a document and a category have been associated with each other;
morphological analysis performing circuitry to perform morphological analysis on each of the multiple pieces of learning data;
extracting circuitry to extract words being predicates from among a plurality of words obtained by the morphological analysis; and
calculation generating circuitry to generate a learned model by calculating pointwise mutual information based on the plurality of words obtained by the morphological analysis, a plurality of extracted words, and a plurality of categories, the learned model being a learned model which outputs a category corresponding to data when the data is inputted,
wherein
the learned model is three-dimensional information indicating a correspondence relationship between the category and two-dimensional information, and
the two-dimensional information is information indicating a correspondence relationship between the plurality of words obtained by the morphological analysis and a plurality of extracted words.

2. The information processing device according to claim 1, wherein when the number of appearances on the word being a predicate and a word obtained by the morphological analysis are less than or equal to a predetermined threshold value, the calculation generating circuitry corrects the learned model by using a constant.

3. The information processing device according to claim 1, wherein in the calculation of the pointwise mutual information, the calculation generating circuitry selects two words from the plurality of words obtained by the morphological analysis and generates a learned model as four-dimensional information by calculating the pointwise mutual information by using the selected two words.

4. The information processing device according to claim 3, wherein when the number of appearances on the word being a predicate and the two words selected from the plurality of words obtained by the morphological analysis are less than or equal to a predetermined threshold value, the calculation generating circuitry corrects the learned model by using a constant.

5. The information processing device according to claim 1, wherein the calculation generating circuitry generates the learned model that outputs the category and a likelihood.

6. An information processing device comprising:
acquiring circuitry to acquire multiple pieces of learning data in each of which a document and a category have been associated with each other;
morphological analysis performing circuitry to perform morphological analysis on each of the multiple pieces of learning data;
extracting circuitry to extract words being predicates from among a plurality of words obtained by the morphological analysis;
calculation generating circuitry to generate a first learned model by calculating pointwise mutual information based on the plurality of words obtained by the morphological analysis and a plurality of extracted words; and
generating circuitry to generate a second learned model based on the multiple pieces of learning data, the first learned model, and a predetermined method, the second learned model being a learned model which outputs a category corresponding to data when the data is inputted,
wherein in the calculation of the pointwise mutual information, the calculation generating circuitry selects two words from the plurality of words obtained by the morphological analysis and calculates the pointwise mutual information by using the selected two words.

7. The information processing device according to claim 6, wherein when the number of appearances on the word being a predicate and the two words selected from the plurality of words obtained by the morphological analysis are less than or equal to a predetermined threshold value, the calculation generating circuitry corrects the first learned model by using a constant.

8. The information processing device according to claim 6, wherein the calculation generating circuitry generates the second learned model that outputs the category and a likelihood.

9. A generation method performed by an information processing device, the generation method comprising:
acquiring multiple pieces of learning data in each of which a document and a category have been associated with each other;
performing morphological analysis on each of the multiple pieces of learning data;
extracting words being predicates from among a plurality of words obtained by the morphological analysis; and
generating a learned model by calculating pointwise mutual information based on the plurality of words obtained by the morphological analysis, a plurality of extracted words, and a plurality of categories, the learned model being a learned model which outputs a category corresponding to data when the data is inputted,
wherein
the learned model is three-dimensional information indicating a correspondence relationship between the category and two-dimensional information, and
the two-dimensional information is information indicating a correspondence relationship between the plurality of words obtained by the morphological analysis and a plurality of extracted words.

10. A generation method performed by an information processing device, the generation method comprising:
acquiring multiple pieces of learning data in each of which a document and a category have been associated with each other;
performing morphological analysis on each of the multiple pieces of learning data;
extracting words being predicates from among a plurality of words obtained by the morphological analysis;
generating a first learned model by calculating pointwise mutual information based on the plurality of words obtained by the morphological analysis and a plurality of extracted words; and
generating a second learned model based on the multiple pieces of learning data, the first learned model, and a predetermined method, the second learned model being a learned model which outputs a category corresponding to data when the data is inputted,
wherein in the calculation of the pointwise mutual information, two words are selected from the plurality of words obtained by the morphological analysis and the pointwise mutual information is calculated by using the selected two words.

11. An information processing device comprising:
a processor to execute a program; and
a memory to store the program which, when executed by the processor, performs processes of,
acquiring multiple pieces of learning data in each of which a document and a category have been associated with each other,
performing morphological analysis on each of the multiple pieces of learning data,
extracting words being predicates from among a plurality of words obtained by the morphological analysis, and
generating a learned model by calculating pointwise mutual information based on the plurality of words obtained by the morphological analysis, a plurality of extracted words, and a plurality of categories, the learned model being a learned model which outputs a category corresponding to data when the data is inputted,
wherein
the learned model is three-dimensional information indicating a correspondence relationship between the category and two-dimensional information, and
the two-dimensional information is information indicating a correspondence relationship between the plurality of words obtained by the morphological analysis and a plurality of extracted words.

12. An information processing device comprising:
a processor to execute a program; and
a memory to store the program which, when executed by the processor, performs processes of,
acquiring multiple pieces of learning data in each of which a document and a category have been associated with each other,
performing morphological analysis on each of the multiple pieces of learning data,
extracting words being predicates from among a plurality of words obtained by the morphological analysis,
generating a first learned model by calculating pointwise mutual information based on the plurality of words obtained by the morphological analysis and a plurality of extracted words, and
generating a second learned model based on the multiple pieces of learning data, the first learned model, and a predetermined method, the second learned model being a learned model which outputs a category corresponding to data when the data is inputted,
wherein in the calculation of the pointwise mutual information, two words are selected from the plurality of words obtained by the morphological analysis and the pointwise mutual information is calculated by using the selected two words.
